(19) United States
(12) Patent Application Publication
(10) Pub. No.: US 2021/0400939 A1
(43) Pub. Date: Dec. 30, 2021

(54) Sinker With Beads Confined Within A Concealed Tube

(71) Applicant: Dennis Wayne Stump, JR., Madison Heights, VA (US)

(72) Inventor: Dennis Wayne Stump, JR., Madison Heights, VA (US)

(21) Appl. No.: 17/348,036

(22) Filed: Jun. 15, 2021

Related U.S. Application Data
(60) Provisional application No. 63/044,704, filed on Jun. 26, 2020.

(51) Int. Cl. A01K 95/00; A01K 95/02

(52) U.S. Cl. CPC A01K 95/005; A01K 95/02

(57) ABSTRACT

The sinker has a swivel that contains an opening to allow the insertion and attachment of fishing line. The sinker contains beads confined within a tube internally affixed to the swivel.

### BACKGROUND OF THE INVENTION

### 1. Field of the Invention

This invention relates to a sinker that contains an internal rattling chamber. The sinker comprises a weighted body which comprises a longitudinal cavity therein concealing a tube containing beads. The swivel has an elongated cylindrical base extending into the sinker, allowing the tube to be affixed to the swivel while being concealed.

Many fishing techniques require sinkers that are used only to get the bait to the desired depth. They offer no fish attracting functionality or features.

### OBJECTIVES OF THE INVENTION

Accordingly, it is an object of this invention to provide improved fishing sinkers.

Another object is to provide a sinker that can be used to get the bait to the desired depth and utilize an internal rattle that mimics crawfish and attract gamefish in a non-threatening manner.

### BRIEF DESCRIPTION OF THE DRAWING

FIG. 1 is a perspective view of a sinker with two beads confined within a concealed tube;

FIG. 2 is a front elevation view of FIG. 1, the rear elevation view being a mirrored image thereof;

FIG. 3 is a left-side elevation view of FIG. 1, the right-side elevation view being a mirrored image thereof;

FIG. 4 is a top plan view of FIG. 1;

FIG. 5 is a bottom plan view of FIG. 1;

FIG. 6 is a cross-sectional view of FIG. 1, taken generally along line B-B showing the embodiment of my new invention.

### DETAILED DESCRIPTION OF THE PREFERRED EMBODIMENT

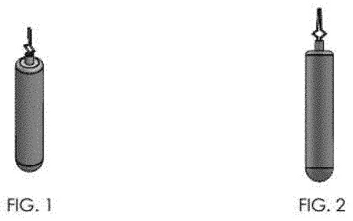

Firstly, referring to FIG. 1 which is a perspective view of a sinker with two beads confined within a concealed tube, shows the sinker body and the upper portion of a swivel that contains an opening to allow the insertion and attachment of fishing line;

FIG. 2 which is a front elevation of FIG. 1 displays the same forementioned swivel components. The rear elevation being a mirror image thereof;

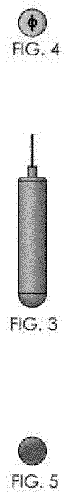

FIG. 3 which is a left-side elevation of FIG. 1 displays the same forementioned swivel components. The right-side elevation being a mirror image thereof;

FIG. 4 which is a top plan view of FIG. 1 displays the same forementioned swivel components;

FIG. 5 which is a bottom plan view of FIG. 1 is cylindrical in shape, and shows no components;

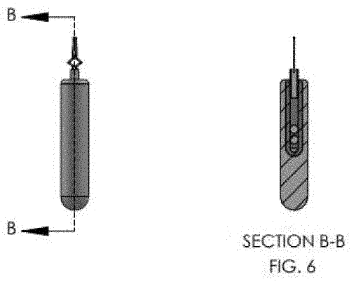

Now referring to FIG. 6 which is a cross-sectional view of FIG. 1, taken generally along line B-B exhibiting a cavity that contains two beads confined within a concealed tube. The tube in FIG. 6 is permanently affixed to the base of the swivel shown in FIG. 1;

The embodiment of the invention in which an exclusive property or privilege is claimed is defined as follows:

1. Sinker comprised of beads confined within a tube.

2. The sinker defined in claim 1, wherein the tube is concealed and affixed to the base of the swivel.

3. The sinker defined in claim 1, wherein the tube is partially concealed and affixed to the base of the swivel.

4. The sinker defined in claim 1, wherein the tube is fully exposed and affixed to the base of the swivel.

5. The sinker defined in claim 1, wherein the tube is concealed and not affixed to the base of the swivel.

6. The sinker defined in claim 1, wherein the tube is partially concealed and not affixed to the base of the swivel.

7. The sinker defined in claim 1, wherein the tube is fully exposed and not affixed to the base of the swivel.

8. The sinker defined in claim 1, wherein the sinker is made of lead.

9. The sinker defined in claim 1, wherein the sinker is made of tungsten.

10. The sinker defined in claim 1, wherein the sinker is made of brass.

11. The sinker defined in claim 1, wherein the sinker is made of aluminum.
